(19) United States
(12) Patent Application Publication
(10) Pub. No.: US 2001/0054308 A1
(43) Pub. Date: Dec. 27, 2001

(54) Methods and apparatus for measuring suspended-substance concentrations

(76) Inventors: Hideaki Komiya, Tokyo (JP); Saichiro Morita, Tokyo (JP); Keijiro Uchiyama, Tokyo (JP); Takashi Ochi, Tokyo (JP)

Correspondence Address: MOONRAY KOJIMA, BOX 627, WILLIAMSTOWN, MA, 01267, US

(21) Appl. No.: 09/812,213

(22) Filed: Mar. 19, 2001

(30) Foreign Application Priority Data
Jun. 26, 2000 (JP) 2000/190,657
Aug. 31, 2000 (JP) 2000/263,609
Dec. 7, 2000 (JP) 2000/372,529
Jan. 25, 2001 (JP) 2001/016,578

(51) Int. Cl. G01N 15/06

(52) U.S. Cl. 73/61.71

(57) ABSTRACT

Method and apparatus for measuring suspended substance concentrations, wherein the method includes measuring the concentration of suspended substances mixed with a liquid by detecting pressure difference between two points distantly located in the depth direction of the liquid, calculating the average density of the liquid between the two points from the pressure difference, and then calculating difference between the average density and a predetermined reference density of the liquid as an index for determining the suspended substance concentration, whereby real time, continuous measurement and easy maintenance and control with high accuracy and wide measuring range are attained.

### BACKGROUND OF THE INVENTION

1. Field of Invention

This invention relates to methods and apparatus for measuring suspended substance concentrations in a liquid by measuring pressure difference between two points in the depth direction of the liquid, and determining average density of the liquid between the two points.

2. Description of the Prior Art

An increase in the amount of foreign matter suspended in a liquid, for example, sand, gravel, or dirt in a reservoir, river, etc, may adversely affect the ecological system. For example, the suspended matter may accumulate at the bottom of a lake behind a dam, and cause damage to generation equipment which use the water to power the generation of electric by the presence of the suspended foreign matter. Accordingly, it is routine practice to measure suspended substance concentrations in order to control the quality of reservoirs, rivers, and the like. When the concentration of foreign matter exceeds a control limit, the inflow of water from rivers to the reservoir behind a dam is stopped.

Conventional methods for measuring suspended substance concentrations include, for example, (a) a method involving placing an optical detector at a measuring point in a stream of running water, radiating light at the optical detector through running water, and detecting the intensity of the transmitted or scatter light, and (b) a method involving collecting a sample from the running water and measuring the turbidity of the sample in an optical manner, for example.

The conventional methods, however, have the following and other problems: (1) The method of collecting a sample from a stream of running water is not a method which is automated. Consequently, real time, continuous measurement is not practical or feasible. (2) Although capable of automatic continuous measurement, the method involving placement of an optical detector at a measuring point in a stream of running water cannot easily perform long term, continuous and consistent measurement since the optical detector is placed under water and hence may itself become contaminated with foreign matter, such as earth and sand, accumulating thereon or adhering thereto. Accordingly, cost of maintenance and control, such as removing the foreign matter from the detector or replacing the detector, is increased. (3) An alarm must be turned ON, for example, at a concentration of approximately 30 ppm for water in a reservoir used to power electric generation, and at concentrations of 1000 to 10000 ppm for regular, non-hydroelectric, dams. On the other hand, the method of placing an optical detector at a measuring point in a stream of liquid suffers significant measurement errors due to the color of the suspended foreign material such as earth and sand accumulated thereon or adhered thereto. Hence, the measuring range is limited to about 1000 to 2000 ppm. Since the measurement range provided by conventional methods is narrow, it cannot be used to control the water quality of reservoirs and rivers, and use thereof is limited to specific applications.

### SUMMARY OF THE INVENTION

Accordingly, an object of the invention is to overcome the aforementioned and other disadvantages, problems, and deficiencies of the prior art.

According to the invention, the pressure difference between two points located at a distance from each other in the depth direction of a liquid is detected with a differential pressure transmitter, the average density of the liquid between the two points is calculated from the pressure difference, and the difference between the average density and a reference density of the liquid is used as an index for measuring the suspended substance concentration. Accordingly, the invention provides methods and apparatus for suspended substance concentrations that provide real time, continuous measurement, easy maintenance and control, with high accuracy and wide range of measurement.

Other features, advantages, effects and aspects of the invention are set forth hereinbelow.

### BRIEF DESCRIPTION OF THE DRAWINGS

FIG. 1 is a schematic view depicting an illustrative method of measuring suspended substance concentrations according to the invention.

FIGS. 2A and 2B are graphs depicting change in density of water with temperature and temperature characteristics of a differential pressure transmitter.

FIG. 3 is a schematic view depicting a first illustrative embodiment of the invention.

FIGS. 4A and 4B are schematic views depicting main components of the illustrative apparatus for measuring suspended substance concentrations of FIG. 3.

FIG. 5 is a schematic view depicting a second illustrative embodiment of the invention.

FIGS. 6A and 6B are schematic views depicting main components of the illustrative apparatus for measuring suspended substance concentrations of FIG. 5.

FIG. 7 is a schematic view depicting a third illustrative embodiment of the invention.

FIG. 8 is a schematic view depicting an illustrative apparatus for measuring suspended substance concentrations of the invention, wherein peripheral equipment is connected to the apparatus.

FIG. 9 is a schematic view depicting a shell wherein the sensor unit of FIG. 5 is housed.

### DETAILED DESCRIPTION OF THE PREFERRED EMBODIMENTS

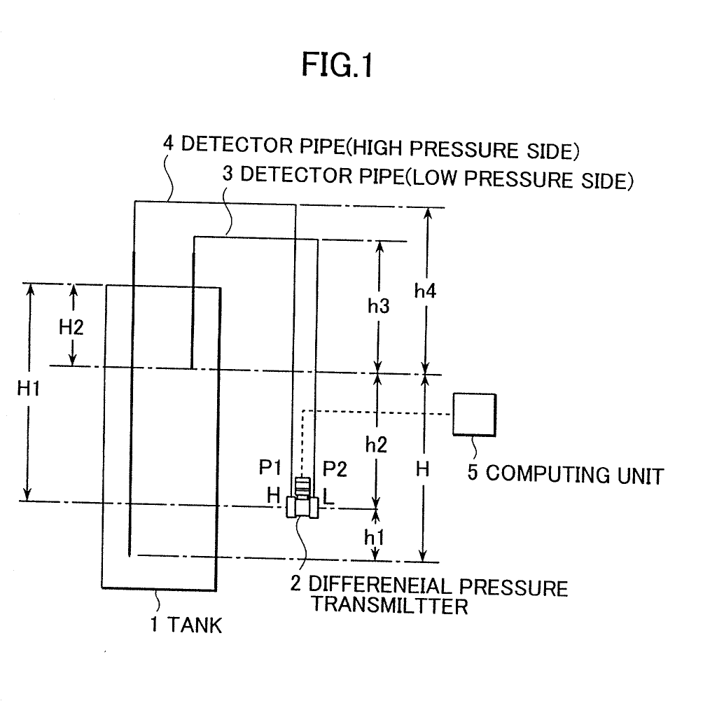

In FIG. 1 a tank 1, corresponding,for example, to a dam or river, wherein suspended substance concentrations are to be measured, is filled, for example, with water. A differential pressure transmitter 2 is provided with a diaphragm (not shown in FIG. 1) which, once provided inputs of high and low pressures, detects the difference between the pressures. The transmitter 2 converts the detected pressure difference to an electric signal and outputs the electric signal. Connected to the input stage of transmitter 2 are a detector pipe 3, which is disposed on the low pressure side, and a detector pipe 4, which is disposed on the high pressure side, both inserted in the water to given depths thereof, as depicted. The tip of detector pipe 4 is inserted into tank 1 at a location which is deeper than that of detector pipe 3,such as by a distance H. The interiors of detector pipes 3 and 4 are either water sealed or water purged. A computer unit 5 is connected to transmitter 2 and is provided,as an input, an output signal provided by transmitter 2.

In this measurement method, a high pressure P1 and a low pressure P2 are applied to differential pressure transmitter 2, as represented by below equations (1) and (2):

P1=ρH1−ρ0(H1+h1)+ρ0(h1+H1+H−h4)+P0 (1)

P2=ρH2−ρ0(H2+h2)+ρ0(h2+H1+H−h3)+P0 (2)

wherein ρ is the average density of water between the tips of detector pipe 4 and detector pipe 3 in the tank. ρ0 is the density of water sealed inside detector pipe 4 and detector pipe 3. H is the distance from the tip of detector pipe 4 to the tip of detector pipe 3. H1 is the distance from the center point of the diaphragm of the transmitter 2 to the top end of tank 1. H2 is the distance from the tip of detector pipe 3 to the top end of tank 1. h1 is the distance from the tip of detector pipe 4 to the center point of the diaphragm of transmitter 2. h2 is the distance from the tip of detector pipe 3 to the center point of the diaphragm of transmitter2. h3 is the distance from the top end of detector pipe 3 to the tip of detector pipe 3. h4 is the distance from the top end of detector pipe 4 to the tip of detector pipe 3. P0 is atmospheric pressure.

Since H1−H2=H, assuming h3=h4, transmitter 2 detects pressure difference (P1−P2) given by below equation (3) using the diaphragm, according to equation (1) and (2). Transmitter 2 then converts the pressure difference to an electric signal.

P1−P2=H(ρ−ρ0) (3)

Since H and ρ0 in equation (3) are previously known, computer unit 5 calculates average density ρ, given an output signal of the pressure difference from transmitter 2.

Computer unit 5, having previously stored therein values of H and ρ0, as well as the reference density of water, in which no suspended substance is mixed, as known values. Computer unit 5 calculates difference between evaluated average density ρ of water and stored reference density of water and outputs the difference as an index for determining the suspended substance concentrations.

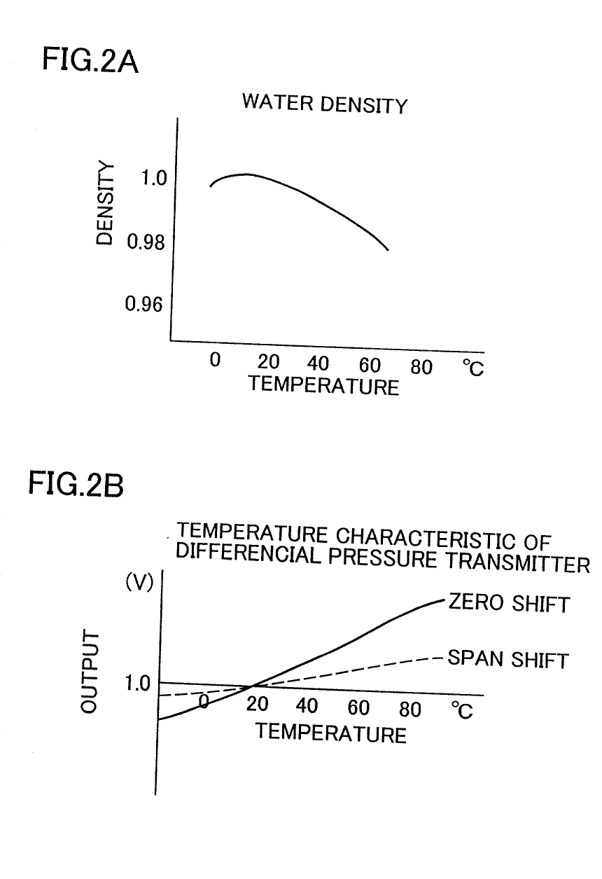

The density of water changes according to the temperature thereof. For example, a density change occurs equivalent to an approximately 250 ppm change in the suspended substance concentration for a temperature change of 1° C. Accordingly, it is possible to measure suspended substance concentrations more precisely, by measuring the temperature inside tank 1 using a thermometer, not shown, and then correcting the given density according to a priorly obtained relationship between the temperature and density, such as shown in FIG. 2A. The temperature based correction may be made using computer unit 5.

Detector pipe 3, provided as a low pressure detector, and detector pipe 4, provided as a high pressure detector, are sealed using water, in which there are no suspended substances mixed therein, as a sealing fluid. In this case, both the liquid with which tank 1 is filled and the sealing fluid are water. Accordingly, temperature driven changes in the density of water within tank 1 and in the density of water sealed inside detector pipe 3 and detector pipe 4 are cancelled mutually. Hence, temperature based correction is not needed.

The foregoing function is described in detail with reference to FIG. 1. High pressure P1 and low pressure P2 applied to transmitter 2 and average density ρ of water are represented by below equations (4), (5) and (6).

P1=P0+ρH−0h1+(ρ0+Δρₛ)H−ρ0h1 (4)

P2=P0+ρ0h2 (5)

ρ=ρ0+Δρₛ (6)

wherein Δρₛ is a density change due to suspended substance in water within the tank 1.

Since H=h1+h2, the pressure difference (P1−P2) is represented by below equation (7).

P1−P2=ρH−ρ0(h1+h2)=ΔρₛH (7)

Hence, density ρ0 is cancelled from the equation and only a density change due to suspended substance in water within tank 1, is detected.

An output error, such as zero shift or span shift, occurs in differential pressure transmitter 2 due to a change in the ambient temperature. Thus, it is possible to measure suspended substance concentrations more precisely, by measuring the ambient temperature of transmitter 2 using a thermometer , not shown, and then correcting the output of transmitter 2 according to a previously obtained temperature characteristic thereof, such as shown in FIG. 2B. The temperature based correction is made by computer unit 5.

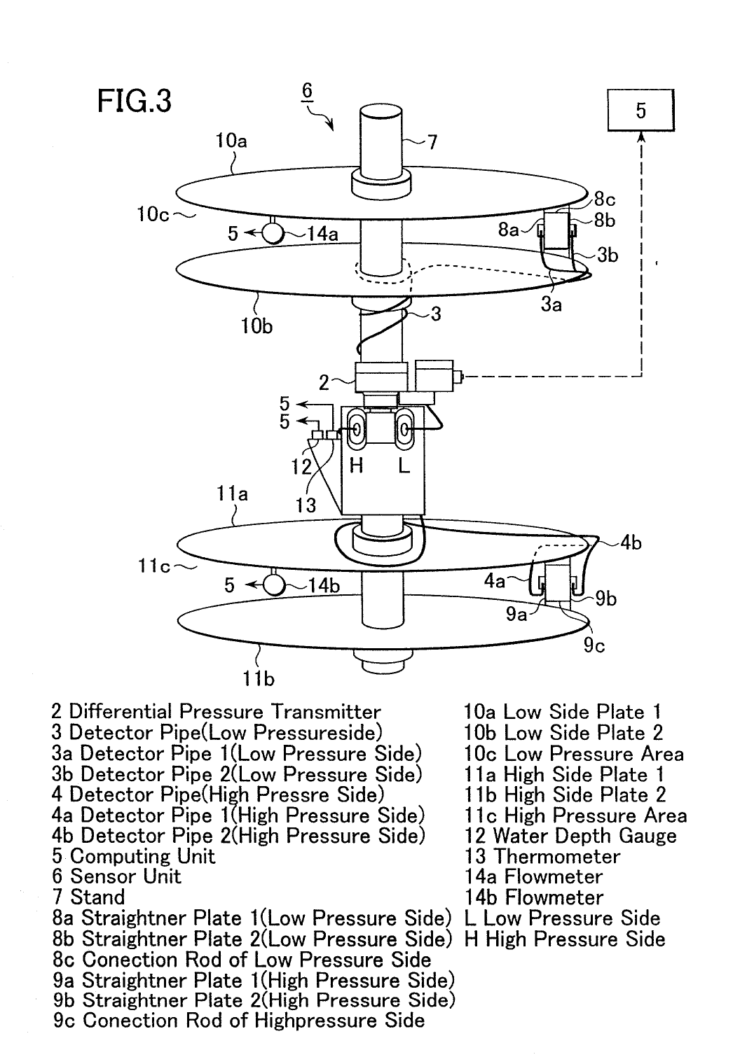

FIG. 3 shows a first illustrative embodiment of the invention, wherein a sensor unit 6 is connected to the following components so as to form an integral structure: a stand 7, a first low pressure straightener plate 8a, a second low pressure straightener plate 8b, a first low pressure detector pipe 3a, a second low pressure detector pipe 3b, a third low pressure detector pipe 3, a first high pressure straightener plate 9a, a second high pressure straightener plate 9b, a first high pressure detector pipe 4a, a second high pressure detector pipe 4b, a third high pressure detector pipe 4, a differential pressure transmitter 2, a first low pressure side plate 10a, a second low pressure side plate 10b, a first high pressure side plate 11a, and a second high pressure side plate 11b. The sensor unit 6 is submerged in the tank 1, or in a stream of water, such as a river, or in a reservoir behind a dam, for example. The designation of low pressure and high pressure for the straightener plates 8, 9, detector pipes 3,4, and plates 10,11 mean that the integral structure shown in FIG. 3 is disposed such that the respective named components are on the high pressure side or the low pressure side.

Fixed onto the upper section of stand 7 are first low pressure side plate 10a, and second low pressure side plate 10b, which are circular in shape, for example, and are provided as first ripple removal means, wherein first plate 10a and second plate 10b are separated from each other at a given distance with stand 7 disposed at the centers thereof, as depicted. A low pressure area 10c is thus formed in the space between the two side plates 10a and 10b. In addition, the first and second high pressure side plates 11a and 11b, which are also circular in shape, for example, are provided as second ripple removal means, and are fixed on stand 7 at a position downward (i.e. in the depth direction of the liquid, such as liquid stream flow) from the first and second low pressure plates 10a and 10b, wherein first and second plates 11a and 11b are separated at a given distance from each other and connected to stand 7 through the centers thereof. A high pressure area 11c is thus formed in a space between the first and second high pressure plates 11a and 11b.

To simplify explanation of the various components, the various components, such as the straightener plates, holes, tubes and detector pipes, which are disposed in the high pressure area may be designated by such terms as “high pressure”, “high side”, or “high” followed by the designated component, such as “high pressure hole”, “high side hole” or merely “high hole”. In a similar manner, the components disposed in the low pressure area may be designated by such terms as “low pressure”, “low side”, or “low” followed by the designated component, such as “low pressure holed”, “low side hole” or merely “low hole”. It is to be understood that these terms may be used interchangeably.

Fixed between first high plate 11a and second low plate 10b on stand 7 is transmitter 2. A water depth gauge 12 and a thermometer 13 are fixed in the vicinity of transmitter 2. A flowmeter 14a is fixed onto first low plate 10a so as to be positioned in low pressure area 10c. Similarly, a flowmeter 14b is fixed onto first high plate 11a so as to be positioned in high pressure area 11c.

The first low straightener plate 8a and second low straightener plate 8b, which are circular in shape, for example, and act as first ripple removal means, are connected to each other via a connection rod 8c so as to be opposite to each other and positioned in the low pressure area 10c. Both straightener plates 8a and 8b are fixed onto first low plate 10a. More specifically, the first low straightener plate 8a and second low straightener plate 8b are arranged so that the surfaces thereof are perpendicular to those of first and second low plates 10a and 10b.

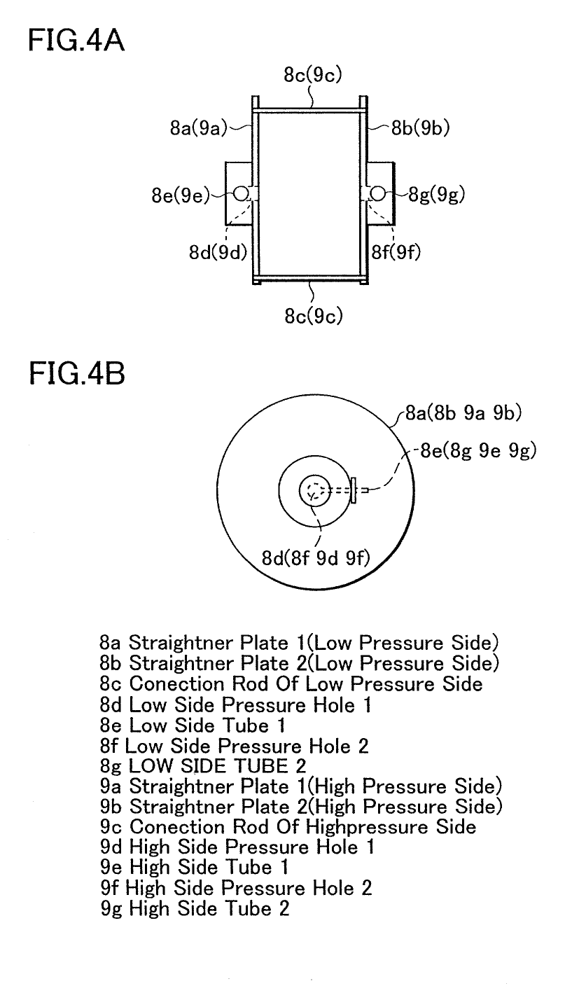

FIG. 4A shows how first low pressure straightener plate 8a and second low pressure straightener plate 8b are connected to each other; and FIG. 4B shows a plan view of the first low pressure straightener plate 8a, or second low pressure straightener plate 8b; wherein first low pressure hole 8d is formed in first low pressure straightener plate 8a to introduce water pressure to be in contact with one side thereof opposite to second low pressure straightener plate 8b when first low pressure straightener plate 8a is submerged in a liquid, such as a stream of water. A first low side tube 8e leading into first low pressure hole 8d is connected to first low pressure straightener plate 8a. Also, as shown in FIG. 3, the tip of first low pressure detector pipe 3a is connected to first low pressure tube 8e so as to lead into the first low pressure hole 8d.

Before continuing, a further clarification of term usage may be in order. In the specification and claims, various terms are used interchangeably, namely, various components are modified by terms involving placement thereof in a low pressure or high pressure side or area. As priorly stated, these terms may designate a low pressure component, or low pressure side component, or low side component, or simply low component, and as to the high pressure side or area, the terms may designate a high pressure component, or high pressure side component, or high side component, or simply high component. These terms are used interchangeably and have the same meanings namely exposure of the component to the named pressure.

A second low pressure hole 8f is formed in second low pressure staightner plate 8b in a position level with first low pressure hole 8d, in order to introduce water pressure to be in contact with one side of second low straightener plate 8b opposite to first low straightener plate 8a. A second low side tube, 8g leading into second low hole 8f is connected to second low straightener plate 8b. Also, as shown in FIG. 3, the tip of second low detector pipe 3b is connected to second low side tube 8g to lead into second low pressure hole 8f.

In FIG. 3, first low detector pipe 3a and second high detector pipe 3b are joined to form a single detector pipe, i.e. a low pressure detector pipe 3. Low pressure detector pipe 3 is connected to the low pressure side “L” of transmitter 2. At this point, first low pressure detector pipe 3a, second low pressure detector pipe 3b, and low pressure detector pipe 3 are sealed with a sealing fluid, such as water.

The high pressure side of sensor unit 6 is similar to the low pressure side thereof. More specifically, first low pressure straightener plate 9a and second low pressure straightener plate 9b, which are circular in shape, for example, serve as a second ripple removal means, and are connected to each other with a connection rod 9c so as to be opposite each other and positioned in high pressure area 1c. Both straightener plates 9a and 9b are fixed to first high side plate 11a. First low straightener plate 9a and second low straightener plate 9b are arranged so that the surfaces thereof are perpendicular to those of the first and second high side plates 11a and 11b.

First low straightener plate 9a and second low straightener plate 9b are structurally the same as first low straightener plate 8a and second low straihgtner plate 8b, shown in FIGS. 4A and 4B. That is, a first high pressure hole 9d is formed in first high straightener plate 9a to intoduce water pressure to be in contact with one side thereof opposite to second high straightener plate 9b when first high straigthner palte 9a is submerged in the liquid, such as stream of water. A first high tube 9e leading into first high pressure hole 9d is connected to first high straightener plate 9a. Also, as shown in FIG. 3, the tip of first high detector pipe 4a is connected to first high side tube 9e so as to lead into first high side hole 9d.

A second high side hole 9f is formed in second high straightener plate 9b in a position level with first high side hole 9d, to introduce water pressure to be in contact with one side of second high straightener plate 9b opposite to first high straightener plate 9a. A second high tube 9g leading into second high hole 9f is connected to second high straigthner plate 9b. Also, as shown in FIG. 3, the tip of second high detector pipe 4b is connected to second high tube 9g so as to lead into second high hole 9f.

The first high detector pipe 4a and second high detector pipe 4b are joined into a single detector pipe, i.e. high detector pipe 4.

The high detector pipe 4 is connected to high pressure side “H” of transmitter 2. At this point, first high detector pipe 4a, second high detector pipe 4b, and high detector pipe 4 are sealed with a sealing fluid, such as water.

The operation of the embodiment of FIG. 3 is as follows. Sensor unit 6 is submerged in liquid, such as water in a reservoir behind a dam, in a river, etc. If the liquid is flowing, sensor unit 6 is oriented and submerged therein so that the liquid will flow between first low pressure straightener plate 8a and second low pressure straigthner plate 8b, and between first low pressure straightener plate 9a and second low pressure straightener plate 9b. Hence, the pressure of liquid, for example, flowing between first low pressure straightener plate 8a and second low pressure straigthner plate 8b is introduced through a first hole pressure hole 8d into first low pressure detector pipe 3a, thereby pressurizing the fluid sealed therein. Pressure is also introduced through second low pressure hole 8f into second low pressure detector pipe 3b. Since first low pressure detector pipe 3a and second low pressure detector pipe 3b are joined into low pressure detector pipe 3, the pressure introduced into the first and second detector pipes 3a and 3b are averaged and the resulting average pressure is introduced through low detector pipe 3 to the low pressure side “L” of transmitter 2. Likewise, pressures introduced into the first and second high detector pipes 4a and 4b are averaged and the resulting average pressure is introduced through high detector pipe 4 to the high pressure side “H” of transmitter 2. Since the low and pressures introduced into the transmitter 2 are average pressures, any error included in the measured pressure is minimal.

In the foregoing process, first low straightener plate 8a and second low straightener plate 8b remove ripples and hence streamline the flow of liquid by limiting the region through which the liquid flows. Accordingly, influence exerted upon pressure detection by horizontal waves, in particular, produced in the direction perpendicular to the surfaces of the first and second low straightener plates 8a and 8b, is reduced.

Similarly, the first and second low plates 10a and 10b remove ripples and hence streamline the flow of liquid, by limiting the region through which the liquid flows, to the area 11c. Accordingly, influence is exerted upon pressure detection by vertical waves, in particular, produced in the depth direction of the liquid, is reduced.

The effects of streamlining the liquid flow brought about by the first low straightener plate 9a and second low straightener plate 9b, and by the first and second high side plates 11a and 11b, are the same as those produced on the low pressure side of sensor unit 6, as previously discussed.

Transmitter 2 detects the difference between the lows and high pressures applied thereto by means of a diaphragm built therein, not shown, and converts the difference to an electrical signal. According to the output of transmitter 2, computer unit 5 calculates the average density of liquid between first low hole 8d (or second low hole 8f) and the first high hole 9d (or second high hole 9f). Then, computer unit 5 calculates the difference between the average density thus evaluated and the previously evaluated and stored reference density of the liquid which is then used as an index for determining the concentrations of suspended substances.

Also, depth and pressure measured with water depth gauge 12, temperature measured with thermometer 13, and flow rate measured with flowmeters 14a and 14b are transmitted to computer 5, where the computer performs corrective calculations which are routinely made with respect to the output values provided by transmitter 2. More specifically, corrections are made to the measured density and the output of transmitter 2, according to previously obtained data on change in density of water with temperature and the temperature characteristics of the differential pressure transmitter 2, such as shown in FIGS. 2A and 2B. The values, as measured and described above, are also utilized as reference data representing conditions for measuring concentrations of the suspended substances.

In the embodiment of FIG. 3, the liquid under test contains the suspended substances, and the liquid used to seal the detector pipes 3 and 4 contains no suspended substances, may both be water. In this case, there is no need to make any temperature based density corrections since the temperature driven changes in the density of water are cancelled, as discussed above.

When the error tolerance for the measured concentration of suspended substance is relatively large, a low pressure hole may be formed in either the first low pressure straightener plate 8a alone, or the second low pressure straightener plate 8b alone. Then, the low pressure detector peipe 3 may be connected to either the first low straightener plate 8a or the second low straightener plate 8b so as to lead into the low pressure hole. Similarly, a high pressure hole may be formed in either the first high pressure straightener plate 9a alone or second high pressure straightener plate 9b alone. Then, the high detector pipe 4 may be connected to either the first high straight plate 9a or the second high straightener plate 9b so as to lead into the high pressure hole.

In the foregoing embodiment, the pressure difference between two points disposed at a distance from each other in the depth direction of the liquid is detected using the transmitter 2 without any necessity of using any optical measuring devices; the average liquid density between the two points is calculated according to the detected pressure difference; and the difference between the average density and a reference density of the liquid is used as an index for determine the concentration of the suspended substance. Hence, and advantageously, with the invention, it is possible to measure the concentration in a precise manner, continously, and in real time, while keeping sensor unit 6 submerged for a long period of time in the liquid. Thus, advantageously, amount of work involved in maintenance and control of the apparatus is reduced substantially, such as to task of zero point adjustment of the transmitter 2. Also, since the measuring range is dependent on the measurement accuracy of the differential pressure transmitter 2, advantageously, it is also possible with the invention to measure the concentration over a broad range, for example, as wide as from 30 ppm to 70,000 ppm

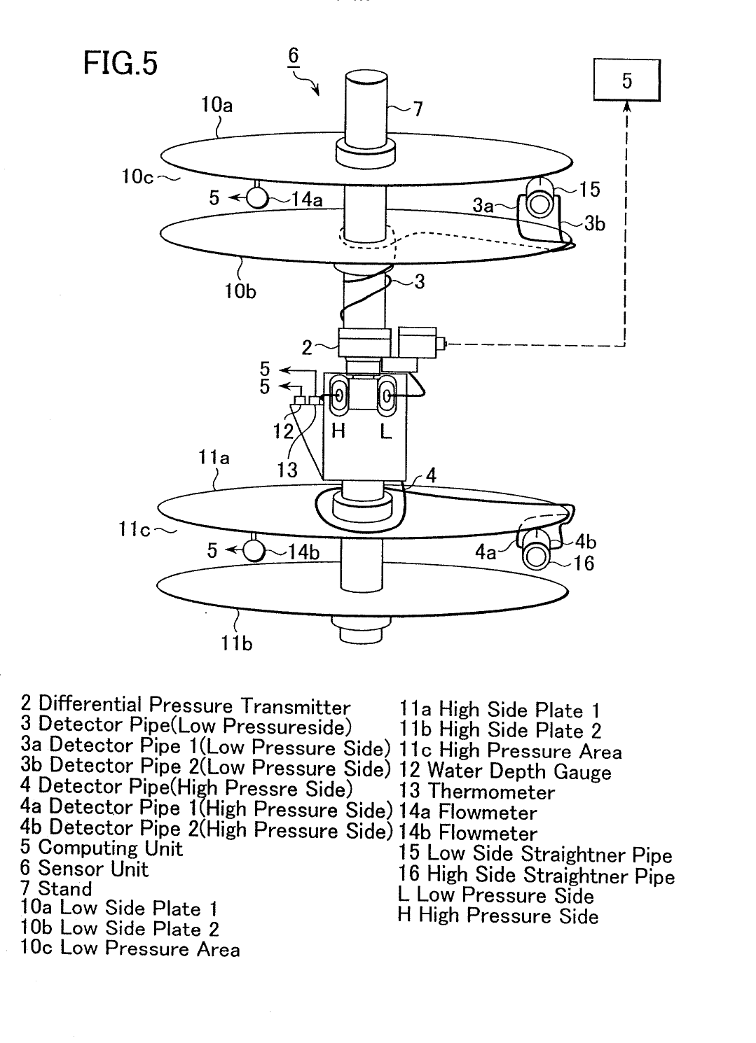

FIG. 5 shows a second illustrative embodiment of the invention, wherein first low pressure straightener plate 8a and second low pressure straightener plate 8b shown in FIG. 3 are replaced with a low pressure straightener pipe 15 which acts as a first ripple removal means. Similarly, first low pressure straightener plate 9a and second low pressure straightener plate 9b are replaced with a high pressure straightener pipe 6 which acts as a second ripple removal means. In FIG. 5, the components identical to those in FIG. 3 have similar reference symbols and description thereof is omitted hereat for sake of clarity.

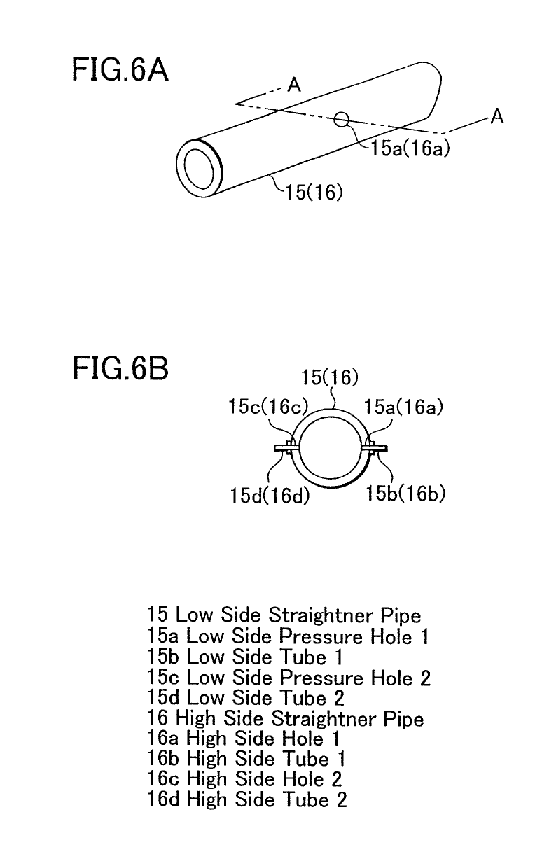

FIG. 6A shows a low pressure straightener pipe 15 ( or high pressure straightener pipe 16); and FIG. 6B shows a cross section thereof as viewed from section line AA′. In FIGS. 6A and 6B, a first low pressure hole 15a is formed in low straightener pipe 15 to introduce water pressure into contact with the inside thereof when low straightener pipe 15 is submerged in water. A first low pressure side tube 15b leading to first low pressure hole 15a is connected to low straightener pipe 15. Also, as shown in FIG. 5, the tip of first low detector pipe 3a is connected to first low side tube 15b so as to lead into first low pressure hole 15a.

A second low pressure hole 15c leading inside low straightener pipe 15 is formed therein in a position opposite to first low pressure hole 15a, wherein second low tube 15d leading into second low hole 15c is connected to low straightener pipe 15. Also, as shown in FIG. 5, the tip of second low detector pipe 3b is connected to second low tube 15d so as to lead into second low hole 15c.

The high straightener pipe 16 is structurally the same as low side straightener pipe 15 shown in FIGS. 6A and 6B. First high pressure hole 16a is formed in high straightener pipe 16 to introduce water pressure to be in contact with the inside thereof when high straightener pipe 16 is submerged in water. A first high tube 16b leading into first high pressure hole 16a is connected to high straightener pipe 16. Also, as shown in FIG. 5, the tip of first high detector pipe 4a is connected to first high tube 16b so as to lead into first high hole 16a. A second high pressure hole 16c leading inside high straightener pipe 16 is formed therein in a position opposite to first high pressure hole 16a, wherein a second low tube 16d leading into high pressure hole 16c is connected to high straightener pipe 15. Also, as shown in FIG. 5, the tip of second high detector pipe 4b is connected to second high tube 16d so as to lead into second high pressure hole 16c.

During measurement, sensor unit 6 is submerged in the liquid, such as water in a reservoir behind a dam, or in a river, etc. If the liquid is flowing, sensor unit 6 is oriented and submerged therein so that the liquid will flow through the low straightener pipe 15 and high straightener pipe 16.

In the process, low straigthner pipe 15 or high straightener pipe 15, removes rippes and thereby streamlines the flow of liquid by limiting the region through which the liquid will flow. Hence, influence exerted upon pressure detection by horizontal and vertical waves produced in the directions perpendicular to and parallel to the cross-section of the low straightener pipe 15 or high straightener pipe 16, is reduced.

When the error tolerance for the measured concentration of concentration of suspended substance is relatively large, as with the embodiment of FIG. 3, only one low side pressure hole need be formed in the low straightener pipe 15. Then, the low detector pipe 3 may be connected to low straightener pipe 15 so as to lead into low pressure side hole. Similarly, only a single high side pressure hole needs to be formed in high straightener pipe 16. Then, high detector pipe 4 may be connected to the high straightener pipe 16 so as to lead into the high pressure hole.

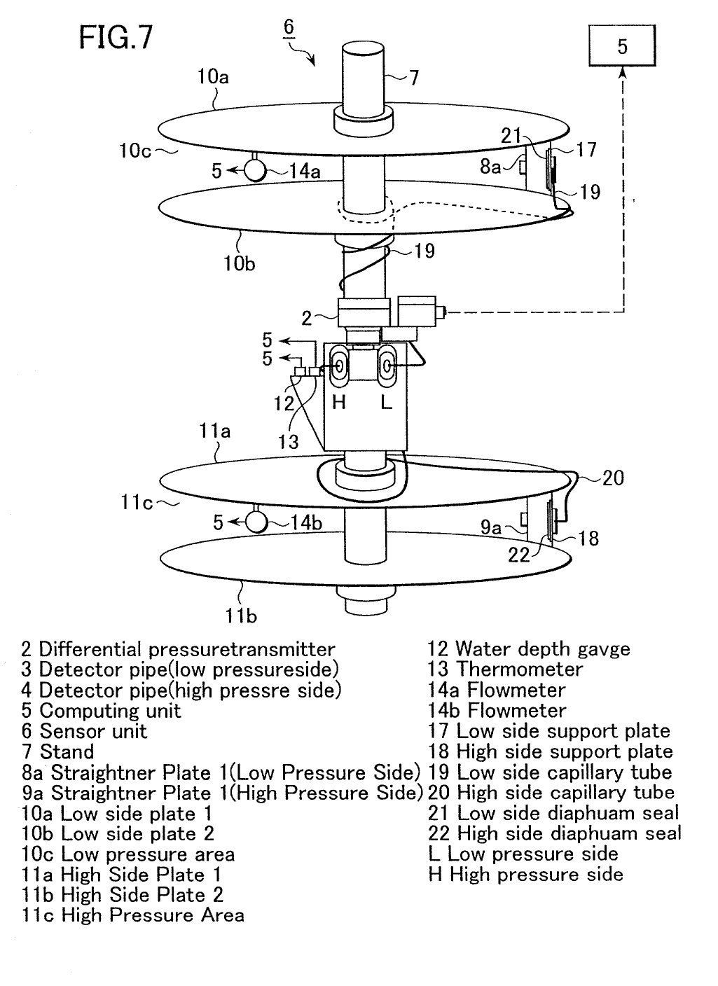

FIG. 7 shows a third illustrative embodiment, wherein low and high support plates 17 and 18 are provided in place of second low straightener plate 8b and second high straightener plate 9b, respectively, shown in FIG. 3. Similarly, low detector pipe 3 and high detector pipe 4 are replaced with low side capillary tube 19 and high side capillary tube 20, respectively. Components which are identical to those in FIG. 3 have the same reference symbols and are not discussed further hereat for sake of clarity.

The low pressure side and high pressure side support plates 17 and 18 are provided in place of first low straightener plate 8a and first high straightener plate 9a, respectively, shown in FIG. 3. Fixed onto one side of low support plate 17, opposite to first low straightener plate 8a is a low diaphragm seal. 21, wherein the low capillary tube 19 is fixed to low support plate 17 so as to lead into the inside thereof. The low support plate 17 and low capillary tube 19 are sealed with a sealing fluid, and a pressure detected by the low diaphragm seal 21 is supplied through low capillary tube 19 to transmitter 2.

Similarly, a high side diaphragm 22 is fixed onto one side of high support plate 18 opposite to first high straightener plate 9a, wherein high capillary tube 20 is fixed to high support plate 18 to lead into the inside thereof. High support plate 18 and high capillary tube 20 are sealed with a sealing fluid, and a pressure detected by high diaphragm seal 22 is inputted through high capillary tube 20 to transmitter 2. Since low support plate 17 functions as a second low straightener plate, and the high support plate 18 functions as a second high straightener plate, the low and high support plates 17 and 18 may be used in combination with first low straightener plate 8a and first high straightener plate 9a, respectively. Thus, the combination of low support plate 17 and first low straightener plate 8a removes ripples and streamlines the flow of liquid by limiting the region through which the liquid can flow. Accordingly, influence exerted upon pressure detection by horizontal waves, in particular, produced in a direction perpendicular to the surfaces of first low straightener plate 8a and low support plate 17, or first high straightener plate 9a and high support plate 18, is reduced.

Since pressure detection units of FIG. 7 embodiment are diaphragm seals, the embodiment, advantageously, provides higher levels of noise immunity performance against such suspended substances as earth, sand, or dirt, as compared with apparatus using pressure detection pipes. Thus, the apparatus is suitable for measuring concentrations of suspended substances, for example,at depths existing in a reservoir behind a dam.

In the prior embodiment, sensor unit 6 is submerged in a liquid. However, where it is not possible to submerge sensor 6 in the liquid being tested, such as when the liquid level is low or for other reasons, the liquid may be sampled and placed into a separate tank, and the sensor 6 submerged thereinto. This makes it possible to precisely measure the concentration of substance suspended in the sampled liquid since there is no influence exerted by ripples of the liquid.

Also, the sealing fluid used for sealing the low side capillary tube 19 and the high side capillary tube 20, contains no suspended substance, whereas the liquid under test contains the substance suspended therein. Both such liquid may be, for example, water. In this case, there is no need for providing temperature based correction, as discussed hereinbefore. When the sealing fluid is different, from the the liquid under test, such as, for example, silicone oil, temperature based density correction may be made for the liquid under test, which can be, for example, water, and for the silicone oil. Using the different fluid for the test and for the sealing, enables the embodiment o more precisely measure the concentration of the suspended substance.

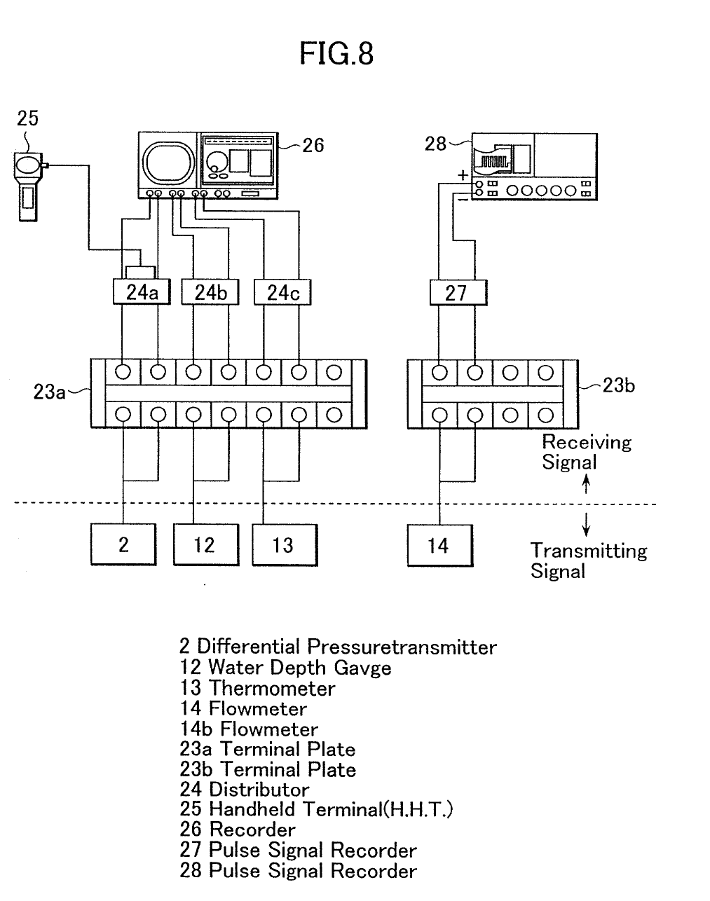

FIG. 8 shows peripheral equipment, such as recorder and hand held terminal, connected to the apparatus of the invention, wherein a differential transmitter 2, a water depth gauge 12, and a thermometer 13 are disposed on the signal transmitting side of the arrangement. Each of the foregoing is connected to terminal plate 23a disposed on the signal receiving side of the arrangement, and are connected to a terminal plate 23a, wherein a hand held terminal ( called “HHT”) is connected to distributor 24a. A recorder 26 is connected to distributors 24a, 24b and 24c. A flowmeter 14, located on the signal transmitting side, and a pulse signal receiver 27, located on the signal receiving side, are connected to terminal plate 23b, with a pulse signal recorder 28 being connected to pulse signal receiver 27.

Output signals of 4 to 20 mA, for example, are provided by transmitter 2, water depth gauge 12, and thermometer 13. Inputs applied to recorder 26 are signals of 1 to 5 volts, for example, resulting from conversion of output signals at distributors 24a, 24b, and 24c. Recorder 26 functions as a computer unit, which performs such tasks as computing concentrations of suspended substances and providing corrective calculations according to outputs from water depth gauge 12 and thermometer 13, and records and displays the results of the foregoing tasks. More specifically, corrections are made to the measured density and the output of the transmitter 2, according to previously obtained data on change in density of water with temperature and the temperature characteristics of transmitter 12, such as shown in FIUS. 2A and 2B, as well as to the temperature of water and the ambient temperature of transmitter 2 measured concurrently with thermometer 13. Hand held terminal 25 is used to externally send signals for providing zero point adjustment (e.g. reference density setting) of transmitter 2, setting the alarm, and changing parameters, through distributor 24a to transmitter 2.

The flowmeter 14 is provided with a rotor driven by running water, for example, and pulse signal receiver 27 emits a buzzer sound once every five revolutions, for example , made by the rotor of flowmeter 14. Pulse signal recorder 28 receives the frequency of the buzzer sound emitted by pulse signal receiver 27 as a frequency of pulses; then, measures the buzzer sound frequency for a given period of time, and then calculates the revolution per second value of the rotor from the measured frequency; and then evaluates the flow speed of the running liquid, such as water. The flow speed, thus evaluated, is used as a reference data at a point in time when the concentration of the suspended substance is measured.

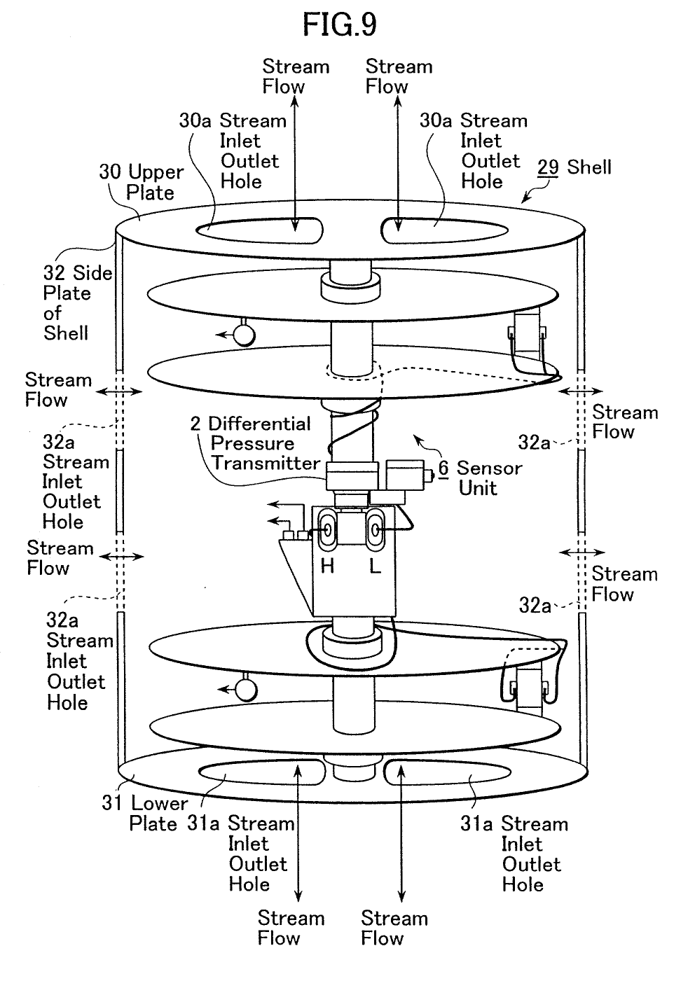

FIG. 9 shows a shell housing the sensor unit of FIG. 3, wherein a shell 29 comprises a hollow cylinder having a circular upper plate 30, a circular lower plate 31, and a cylindrical side plate 32. Stream inlet and outlet holes 30a are formed in the upper plate 30; stream inlet and outlet holes 31a are formed in lower plate 31; and stream inlet and outlet holes 32a are formed in side plate 32. The cross sections of only the main parts are shown with regard to side plate 32 for sake of clarity of description. The stream inlet and outlet holes 30a, 31a, and 32a, may be provided with filters as desired.

During measurement, sensor unit 6 is housed in shell 29 and shell 29 is submerged in the liquid being tested, so that the stream flow, for example, is introduced through stream inlet and outlet holes 30a, 31a and 32a and the concentration of suspended substance is measured. Advantageously, the housing 29 prevents parts of sensor unit 6, for example, transmitter 2, from becoming damaged by foreign material contained in the liquid being tested, such as gravel, dirt, driftwood, etc. Also, the shell 29 inlet and outlet holes 30a, 31a, and 32a, help increase the streamlining of the stream flow by sensor unit 6. Also, advantageously, it is possible with the invention to measure concentrations of suspended substances more precisely and consistently by keeping uniform the ambient temperature of various components, such as the transmitter, mounted on the sensor unit 6. Although sensor unit 6 of FIG.3 is housed in shell 29, the sensor unit 29, the sensor unit of FIG. 5 or FIG. 7 may also be housed in the shell 29 with similar functions and effects.

The various aspects, features, advantages and effects of the invention are set forth below as examples. In one aspect, the invention encompasses a method of measuring concentration of suspended substances mixed with a liquid comprising the steps of detecting pressure difference between two points located in a depth direction of the liquid, calculating from the pressure difference average density of the liquid between the two points, and calculating difference between the average density and a predetermined reference density of the liquid as an index for determining the suspended substance concentration.

In a further aspect, the method comprises the further steps of measuring ambient temperature at which the pressure difference is detected, and the temperature of the liquid, temperature correcting the pressure difference according to the measured ambient temperature, and temperature correcting the average density according to the measured temperature of the liquid.

Thus, without use of optical devices, suspended substance concentration is measured in real time, continuous measurement, easy maintenance and control are attained, and accuracy and increased measurement ranges are attained. Moreover, by temperature correcting the measurements, a more precise measurement of concentration is attained.

The invention also encompasses an apparatus which is submerged in a liquid in which the substance concentration is to be measured is mixed, and comprising a low pressure detector unit and a high pressure detector unit submerged to two points located in a depth direction of the liquid, a differential pressure transmitter for converting difference between pressures detected by the low pressure detector unit and the high pressure detector unit, to electric signals, and computer for calculating average density of the liquid between the two points according to the differential pressure transmitter, and for calculating difference between the average density and a predetermined reference density of the liquid as an index for determining suspended substance concentration.

Another aspect encompasses the low pressure detector unit comprising a first detector pipe connected to the differential pressure transmitter and sealed with liquid in which none of the suspended substance is mixed, and the high pressure detector unit comprising a second detector pipe connected to the differential pressure transmitted and sealed with a liquid in winch none of the suspended substance is mixed. Consequently, there is no need for making temperature based density correction.

A further aspect involves first ripple removal means arranged in vicinity of the first detector pipe for removing ripples of the liquid produced near the first detector pipe, and second ripple removal means arranged in vicinity of the second detector pipe for removing ripples of the liquid produced near the second detector pipe. Accordingly, it is possible for the invention to more precisely measure concentrations without having to account for ripples.

A further feature of the invention encompasses a sensor unit connected to the following components to form an integral unit: the first detector pipe, the second detector pipe, the differential pressure transmitter, the first ripple removal means, and the second ripple removal means, and wherein the sensor unit is submerged in the liquid. Advantageously, the integral structure enables the invention to more precisely measure the concentration in real time, with precision, and accuracy, and wish continuity.

In another feature of the invention, there is provided a shell designed to house the sensor unit and having a plurality of input and output holes therein for passage of the liquid. Advantageously, with such feature, any component mounted for example on the sensor unit, is protected from being damaged by the outside force of the liquid. It also effects streamlining of the liquid flow, and keeps uniform the ambient temperature of the components, such as the differential pressure transmitter. Moreover, the shell enables the invention to more precisely and accurately measure the concentration.

The invention also encompasses an apparatus comprising: first and second low pressure straightener plates which are flat and submerged in the liquid with surfaces thereof positioned substantially perpendicular to a surface of the liquid and arranged to be distant from and opposite to each other; first low pressure hole provided on either opposing surface of the first and second low pressure straightener plates; first detector pipe connected to either of the first and second straightener plates to lead into the first low pressure hole; first and second high pressure straightener plates which are flat and and submerged in a depth direction of the liquid and at a distance from the first and second low pressure straightener plates with surfaces thereof positioned substantially perpendicular to the surface of the liquid and arranged at a distance from and opposite to each other; first high pressure hole on either opposing surface of the first and second high pressure straightener plates; second detector pipe connected to either first or second high pressure plate to lead into the firs high pressure hole; differential pressure transmitter for converting difference between pressures detected by the first and second detector pipes to electric signals; and computer for calculating average density of the liquid according to output of the differential pressure transmitter, and for calculating difference between the average density and a predetermined reference density of the liquid, as an index for determining the concentration of suspended substance. Advantageously, the straightener plates remove horizontal liquid ripples produced near the detector pipes, so that precise measurement of concentration of suspended substances is attained by the invention.

In a further aspect of the invention, there are provided first and second low pressure plates which are flat and arranged to be distant from each other in a depth direction of the liquid to sandwich the first and second low pressure straightener plates; and first and second high pressure plates which are flat and arranged at a distance from each other in a depth direction of the liquid to sandwich the first and second high pressure straightener plates. Advantageously, the plates remove vertical ripples produced near the detector pipes so that a more precise measurement of concentration of substances suspended in the liquid is attained.

A further feature of the invention encompasses a sensor unit fixed to the following components so as to be integral therewith: first low pressure straightener plate, second low pressure straightener plate, first detector pipe, first high pressure straightener plate, second high pressure straightener plate, second detector pipe, differential pressure transmitter, first low pressure plate, second low pressure plate, first high pressure plate, and second high pressure plate, with the sensor unit being submerged in the liquid. Advantageously, the sensor unit having such integral structure enables the invention to provide real time continuous measurement of the the concentration of suspended substances.

Another aspect of the invention encompasses a second low pressure hole formed on a side of the second low pressure straightener plate opposite to the first low pressure straightener plate, wherein a second high pressure hole is formed on a side of the second high pressure straightener plate, and a second low pressure detector pipe connected to the second low pressure plate to lead to the second low pressure hole, and a second high pressure detector plate connected to the second high pressure straightener plate to lead to the second high pressure hole, wherein the differential pressure transmitter comprises means for converting pressure difference between average pressure obtained by averaging pressures detected by the first and second low pressure detector pipes and average pressures detected by the first and second high pressure detector pipes into electric signals. Advantageously, the straightener pipes remove the horizontal ripples produced near the detector pipes and the plates remove the vertical ripples produced near the detector pipes, and the averaging of the different pressures combined provide an apparatus which more precisely measures concentration of suspended subtances, in real time, and in a continuous manner.

Another aspect of the invention encompasses a low pressure straightener pipe submerged in the liquid with a central axis thereof positioned substantially parallel with the surface of the liquid, wherein a first low pressure hole leading inside the low pressure straightener pipe is formed in the low pressure straightener pipe, a first detector pipe is connected to the low pressure straightener pipe to lead into the first low pressure hole, a high pressure straightener pipe submerged in the liquid with a central axis thereof positioned substantially parallel with the surface of the liquid and disposed at a distance from the low pressure straightener pipe in a depth direction of the liquid, wherein a first high pressure hole leading inside the high pressure straightener pipe is formed; a second detector pipe connected to the high pressure straightener pipe to lead into the first high pressure hole; differential pressure transmitter for converting pressure difference between pressures detected by the first and second detector pipes to electric signals; and computer for calculating average density of the liquid according to output of the differential pressure transmitter and for calculating difference between the average density and a predetermined reference density of the liquid as an index for determining concentration of substance suspended in the liquid. Advantageously, the straightener pipes removed ripples produced near the detector pipes. Accordingly, the invention provides more precise measurement of concentration of suspended substances,in real time, and on a continuous basis.

In the different aspects of the invention, one or more of the following advantages are attained: (1) Precision of measurement of concentration of suspended substance(s); (2) Measurement is accomplished in real time; (3) Measurement is done on a continuous basis; (4) Maintenance of the apparatus is greatly reduced and hence economy is greatly increased. (5) Control of the apparatus is enhanced. (6) Accuracy of measurement is increased. (7) The ranges of measurement are extended .

In the invention furthermore comprises first and second low pressure plates which are flat and arranged to be at a distance from each other in the depth direction of the liquid so as to sandwich the low pressure straightener pipes; and first and second high pressure plates are arranged at a distance from each other in the depth direction of the liquid so as to sandwich the high pressure straightener pipes. Advantageously, the plates remove vertical ripples and the straightener pipes remove the horizontal ripples so that accuracy is increased in measurement.

Another aspect of the invention is that the low and high pressure pipes are tubular in shape. The tubular shape has advantages of manufacturing easy and lower fluid resistance.

A further aspect of the invention encompasses a second low pressure hole formed opposite the first low pressure hole, and a second high pressure hole formed opposite the first high pressure hole, and further comprising a second low pressure detector pipe connected to the first low pressure straightener pipe to lead into the second low pressure hole, and second high pressure detector pipe connected to the high pressure straightener peipe to lead into the second high pressure hole, and wherein the differential pressure transmitter comprises means for converting pressure difference between average pressure obtained by averaging pressures detected by the first and second low pressure detector pipes, and average pressure obtained by averaging pressures detected by time first and second high pressure detector pipes into electric signals. Advantageously, the foregoing aspect employees the averaging procedure to optimal effect and makes possible a more precise measurement of the concentration of suspended substances.

A further feature or aspect of the invention encompasses first and second low pressure straightener plates which are flat and submerged in the liquid with surfaces thereof positioned substantially perpendicular to the surface of the liquid and arranged to be at a distance from and opposite to each other; a low pressure diaphragm seal provided on opposing surfaces of the first and second low pressure straightener plates; first and second high pressure straightener plates which are flat and submerged in a depth direction of the liquid and at a distance from each other and from the first and second low pressure straightener plates with surfaces thereof being positioned substantially perpendicular to the surface of the liquid; a high pressure diaphragm seal provided on opposing surfaces of the first and second high pressure straightener plates; a differential pressure transmitter for converting difference between pressures detected by the low and high pressure diaphragm seals to electric signals; and computer for calculating average density of the liquid according to output of the differential pressure transmitter and for calculating difference between the average density and a predetermined reference density of the liquid as an index for determining concentration of the suspended substances. Advantageously, the foregoing components combined to remove horizontal ripples of the liquid near the diaphragm seals to thereby improve the precision of measurement of suspended substance concentrations.

Another aspect of the invention encompasses first and second low pressure plates which are flat and arranged at a distance from each other in a depth direction of the liquid to sandwich the first and second low pressure straightener plates; and first and second high pressure plates which are flat and arranged at a distance from each other in the depth direction of the liquid to sandwich the first and second high pressure straightener plates. Advantageously, these plate further improve the precision of measurement by removing vertical ripples from around the diaphragm seals.

The foregoing description is illustrative of the principles of the invention. Numerous extensions and modifications thereof would be apparent to the worker skilled in the art. All such extensions and modifications are to be considered to be within the spirit and scope of the invention.

What is claimed is:

1. A method of measuring concentration of suspended substances mixed with a liquid, said method comprising the steps of:
detecting pressure difference between two points located in a depth direction of said liquid;
calculating from said pressure difference average density of said liquid between said two points; and
calculating difference between said average density and a predetermined reference density of said liquid as an index for determining said suspended substance concentration.

2. The method of claim 1, further comprising the steps of:
measuring ambient temperature at which said pressure difference is detected and temperature of said liquid;
temperature correcting said pressure difference according to measured ambient temperature; and
temperature correcting said average density according to measured temperature of said liquid.

3. An apparatus to be submerged in a liquid in which suspended substances are mixed in order to measure suspended substance concentration, said apparatus comprising:
low pressure detector unit and high pressure detector unit submerged to two points located in a depth direction of said liquid;
differential pressure transmitter for converting difference between pressures detected by said low pressure detector unit and said high pressure detector unit, to an electrical signal; and
computer means for calculating average density of said liquid between said two points according to output of said differential pressure transmitter, and for calculating difference between said average density and a predetermined reference density of said liquid as an index for determining suspended substance concentration.

4. The apparatus of claim 3, wherein said low pressure detector unit comprises a first detector pipe connected to said differential pressure transmitter and sealed with a liquid in which none of said suspended substances is mixed; and wherein said high pressure detector unit comprises a second detector pipe connected to said differential pressure transmitter and sealed with a liquid in which none of said suspended substances is mixed.

5. The apparatus of claim 3, further comprising:
first ripple removal means arranged in vicinity of said first detector pipe for removing ripples of said liquid produced near said first detector pipe; and
second ripple removal means arranged in vicinity of said second detector pipe for removing ripples of said liquid produced near said second detector pipe.

6. The apparatus of claim 5, further comprising:
a sensor unit, whereat said first detector pipe, said second detector pipe, said differential pressure transmitter, said first ripple removal means, and said second ripple removal means are fixed to said sensor unit so as to be integral therewith; and wherein
said sensor unit is submerged in said liquid.

7. The apparatus of claim 6, further comprising:
a shell designed to house said sensor unit and provided with a plurality of stream inlet/outlet holes for said liquid.

8. An apparatus to be submerged in a liquid in which suspended substances are mixed to measure suspended substance concentrations, said apparatus comprising:
first and second low pressure straightener plates which are flat and submerged in said liquid with surfaces thereof positioned substantially perpendicular to a surface of said liquid and arranged to be distant from and opposite to each other;
first low pressure hole Provided on either opposing surface of said first and second low pressure straightener plates;
first detector pipe connected to either of said first and second straightener plate to lead into the first low pressure hole;
first and second high pressure straightener plates which are flat and submerged in a depth direction of said liquid and at a distance from said first and second low pressure straightener plates, with surfaces thereof positioned substantially perpendicular to said surface of said liquid, and arranged at a distance from and opposite to each other;
first high pressure bole provided on either opposing surface of said first and second high pressure straigthner plates;
second detector pipe connected to either first high pressure straightener plate or second high pressure straightener plate to lead into said first high pressure hole;
differential pressure transmitter for converting difference between pressures detected by said first detector pipe and said second detector pipe, to an electric signal; and
computer means for calculating average density of said liquid according to output of said differential pressure transmitter, and for calculating difference between said average density and a predetermined reference density of said liquid as an index for determining said suspended substance concentration.

9. The apparatus of claim 8, further comprising:
first and second low pressure plates which are flat and arranged to be distant from each other in a depth direction of said liquid to sandwich said first and second low pressure straightener plates; and
first and second high pressure plates which are flat and arranged at a distance from each other in a depth direction of said liquid to sandwich said first and second high pressure straightener plates.

10. The apparatus of claim 9, further comprising a sensor unit fixed to the following so as to be integral therewith: first low pressure straightener plate, said second low pressure straightener plate, said first detector pipe, said first high pressure straightener plate, said second high pressure straightener plates said second detector pipe, said differential pressure transmitter, said first low pressure plate, said second low pressure plate, said first high pressure plate, and said second high pressure plates and wherein said sensor unit is submerged in said liquid.

11. The apparatus of claim 10, further comprising a shell designed to house said sensor unit and provided with a plurality of stream inlet and outlet holes for said liquid.

12. The apparatus of claim 8, wherein a second low pressure hole is formed on a side of said second low pressure straightener plate opposite to said first low pressure straightener plate; and wherein a second high pressure hole is formed on a side of said second high pressure straightener plate; and further comprising:
a second low pressure detector pipe connected to said second low pressure straightener plate to lead to said second low pressure hole; and
a second high pressure detector pipe connected to said second high pressure straightener plate to lead into said second high pressure hole; and wherein
said differential pressure transmitter comprises means for converting pressure difference between average pressure obtained by averaging pressures detected by said first and second low pressure detector pipes and average pressure obtained by averaging pressures detected by said first and second high pressure detector pipes, into electric signals.

13. An apparatus to be submerged in a liquid in which suspended substances are mixed to measure suspended substance concentration, said apparatus comprising:
a low pressure straightener pipe submerged in said liquid with a central axis thereof positioned substantially parallel with a surface of said liquid, wherein a first low pressure hole leading inside said low pressure straightener pipe is formed in said low pressure staightner pipe;
a first detector pipe connected to said low pressure straightener pipe to lead into said first low pressure hole;
a high pressure straightener pipe submerged in said liquid with a central axis thereof positioned substantially parallel with a surface of said liquid and disposed at a distance from said low pressure straightener pipe in a depth direction of said liquid, and wherein a first high pressure hole leading inside said high pressure straightener pipe is formed;
a second detector pipe connected to said high pressure straightener pipe to lead into the first high pressure hole;
a differential pressure transmitter for converting pressure difference between pressures detected by said first detector pipe and said second detector pipe, to an electric signal; and
computer means for calculating average density of said liquid according to output of said differential pressure transmitter and for calculating difference between said average density and a predetermined reference density of said liquid as an index for determining said suspended substance concentration.

14. The apparatus of claim 13, further comprising:
first and second low pressure plates which are flat and arranged to be at a distance from each other in a depth direction of said liquid so as to sandwich said low pressure straightener pipes; and
first and second high pressure plates which are flat and arranged to be at a distance from each other in a depth direction of said liquid so as to sandwich said high pressure straighter pipe.

15. The apparatus of claim 14, further comprising a sensor unit connected to the following so as to be integral therewith: said low pressure straightener pipe, said first detector pipe, said high pressure straightener pipe, said second detector pipe, said differential pressure transmitter, said first low pressure plate, said second low pressure plate, said first high pressure plate, and said second high pressure plate; and wherein
said sensor unit is submerged in said liquid.

16. The apparatus of claim 14, further comprising a shell designed to house said sensor unit and provided with stream inlet and outlet holes for said liquid.

17. The apparatus of claim 13, wherein said low pressure straightener pipe is tubular, and said high pressure straightener pipe is tubular.

18. The apparatus o claim 13, wherein a second low pressure hole is formed opposite to said first low pressure hole, and a second high pressure hole is formed opposite to said first high pressure hole; and further comprising:
a second low pressure detector pipe connected to said low pressure straightener pipe to lead into said second low pressure hole; and
a second high pressure detector pipe connected to said high pressure straightener pipe to lead into said second high pressure bole; and wherein
said differential pressure transmitter comprises means for converting pressure difference between average pressure obtained by averaging pressures detected by said first and second low pressure detector pipes and average pressure obtained by averaging pressures detected by said first and second high pressure detector pipes, into electric signals.

19. An apparatus to be submerged in a liquid in which suspended substances are mixed to measure suspended substance concentration, said apparatus comprising:
first and second low pressure straightener plates which are flat and submerged in said liquid with surfaces thereof positioned substantially perpendicular to a surface of said liquid and arranged to be at a distance from and opposite to each other;
a low pressure diaphragm seal provided on opposing surfaces of said first and second low pressure straightener Plates;
first and second high pressure straightener plates which are flat and submerged in a depth direction of said liquid and at a distance from each other and from said first and second low pressure straightener plates, with surfaces thereof being positioned substantially perpendicular to a surface of said liquid;
a high pressure diaphragm seal provided on opposing surfaces of of said first and second high pressure straightener plates;
a, differential pressure, transmitter for converting difference between pressures detected by said low pressure and high pressure diaphragm seals,to an electric signal; and
computer means for calculating average density of said liquid according to output of said differential pressure transmitter and for calculating difference between said average density and a predetermined reference density of said liquid as an index for determining said suspended substance concentration.

20. The apparatus of claim 19, further comprising:
first and second low pressure plates which are flat and arranged at a distance from each other in a depth direction of said liquid to sandwich said first and second low pressure straightener plates; and
first and second high pressure plates which are flat and arranged at a distance from each other in the depth direction of said liquid to sandwich said first and second high pressure straightener plates.

21. The apparatus of claim 20, further comprising a sensor unit connected to the following to form an integral structure: said first low pressure straightener late, said second low pressure straightener plate, said low pressure diaphragm seal, said first high pressure straightener plate, said second high pressure straightener plate, said high pressure diaphragm seal, said differential pressure transmitter, said first low pressure plate, said second low pressure plate, said first high pressure plate, and said second high pressure plate; and wherein said sensor unit is submerged in said liquid.

22. The apparatus of claim 19, further comprising a shell designed to house said sensor unit and provided with stream inlet and outlet holes for passage of said liquid.
